(19) United States
(12) Patent Application Publication
(10) Pub. No.: US 2023/0094190 A1
(43) Pub. Date: Mar. 30, 2023

(54) PREPARING TWO-DIMENSIONAL MXENES WITH ANTIFERROMAGNETIC PROPERTIES

(71) Applicant: FAYETTEVILLE STATE UNIVERSITY, Fayetteville, NC (US)

(72) Inventors: Daniel E. Autrey, Fayetteville, NC (US); Bhoj Gautam, Fayetteville, NC (US); Shubo Han, Fayetteville, NC (US)

(73) Assignee: FAYETTEVILLE STATE UNIVERSITY, Fayetteville, NC (US)

(21) Appl. No.: 17/486,388

(22) Filed: Sep. 27, 2021

(51) Int. Cl. C01B 32/907

(52) U.S. Cl. CPC C01B 32/907; C01P 2006/42; C01P 2002/72; C01P 2004/03; C01P 2004/04; C01P 2006/40

(57) ABSTRACT

A method of synthesizing a MXene material is provided. A starting MAX phase material can be selected, a reaction time and/or reaction temperature can be determined, and subsequently a MXene material can be generated through etching the MAX phase material in an etching solution based on at least one of the determined reaction time and/or reaction temperature. In some instances, the etching solution is an LiF/HCl solution.

### STATEMENT REGARDING GOVERNMENT FUNDING

This invention was made with government support under grant no. HRD-1800795 awarded by the National Science Foundation. The government has certain rights in the invention.

### FIELD

The technology described herein generally relates to two-dimensional MXenes, more specifically to tunable MXene-based antiferromagnetic materials and the preparation thereof.

### BACKGROUND

In recent years, there has been increased research interest in magneto-transport and related materials due to the high potential for various applications, for example, for use in spintronic applications. Of particular interest is magnetic ordering in two-dimensional (2D) materials. 2D materials such as graphene, transition metal chalcogenides, and hexagonal boron nitrides, for example, have high electrical conductivities but poor magnetic properties.

In contrast to these 2D materials, 2D transition metal carbides and nitrides, referred to as MXenes, can be formed to have tunable electrical and magnetic properties. 2D MXenes having tunable electrical and magnetic properties can achieve favorable material characteristics for use in a wide array of applications such as those related to magnetic sensing, spin filtering, spin valves, and data storage.

Conventional processes dealing with 2D materials, however, have not yielded fabrication methods directed towards tuning the electrical and magnetic properties of 2D transition metal carbides and nitrides. Accordingly, the technology described herein provides advantages in these 2D materials and associated processes, for instance to achieve antiferromagnetic ordering in MXenes, and additionally methods according to the present technology realize tenability of these materials, for instance with respect to magnetization and/or magnetic susceptibility and Neel temperature.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards the preparation of MXene-based materials, for example MXene-based antiferromagnetic materials, the tuning of magnetic properties of two-dimensional MXenes, and the application of such materials.

In one embodiment, a method of synthesizing a MXene material or compound is provided. A starting MAX phase material can be selected, a reaction time and/or reaction temperature can be determined, and subsequently a MXene material can be generated or otherwise synthesized through etching the MAX phase material in an etching solution based on at least one of the determined reaction time and/or reaction temperature. In some instances, the extent of etching may be controlled by adjusting the reaction time and/or the reaction temperature, thereby tuning the antiferromagnetic-paramagnetic (AFM-PM) phase transition temperature of the MXene from about 50K to above room temperature. In some embodiments, the starting MAX phase material can be pre-processed by exposing the material to microwave radiation prior to etching, for instance the MAX phase material can be processed with microwave radiation up to a determined power (e.g. 800 W) for a determined amount of time. In some instances, adjusting the power and the time of preprocessing can influence the extent of etching.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 illustrates example X-ray Diffraction (XRD) patterns of Ti₃AlC₂ and Ti₃C₂Tₓ MXene samples, in accordance with some aspects of the technology described herein;

FIG. 2A is an Atomic Force Microscopy (AFM) image illustrating a synthesized MXene, in accordance with some aspects of the technology described herein;

FIG. 2B is a Scanning Electron Microscopy (SEM) image illustrating a synthesized MXene, in accordance with some aspects of the technology described herein;

FIG. 3A illustrates magnetization versus applied magnetic field of example samples, in accordance with some aspects of the technology described herein;

FIG. 3B illustrates magnetization versus applied magnetic field of example samples, in accordance with some aspects of the technology described herein;

FIG. 3C illustrates magnetization versus applied magnetic field of example samples, in accordance with some aspects of the technology described herein;

FIG. 3D illustrates magnetization versus applied magnetic field of example samples, in accordance with some aspects of the technology described herein;

FIG. 4A illustrates magnetization versus temperature of example samples, in accordance with some aspects of the technology described herein;

FIG. 4B illustrates magnetization versus temperature of example samples, in accordance with some aspects of the technology described herein; and

FIG. 4C illustrates magnetization versus temperature of example samples, in accordance with some aspects of the technology described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Two-dimensional materials based on transition metal carbides have been intensively studied due to their unique properties including metallic conductivity, hydrophilicity and structural diversity and have good potential in many applications including, for example, energy storage, sensing, and optoelectronics. MXenes based on magnetic transition elements show interesting magnetic properties, and further not much is known about the magnetic properties of titanium-based MXenes and control factors in their preparation.

According to aspects of the present technology, magnetic properties of MXenes, for example Ti₃C₂Tₓ MXenes, are controlled during synthesis through control of different chemical etching conditions, such as etching temperature, time, and etching solution. By tuning these parameters, AFM-PM phase transition and the transition temperature of resultant MXenes can depend on the synthesis procedure of these MXenes. Further, the magnetic properties of these MXenes can be tuned by the extent of chemical etching, which can be beneficial for the design of MXenes-based spintronic devices.

In some instances, 2D nano sheets of Ti₃C₂ can be obtained by chemically etching the aluminum layer from Ti₃AlC₂ MAX phase materials with hydrofluoric acid. These materials can be referred to as MXenes due to their similar electronic properties to graphene. MXenes have a general formula of Mₙ₊₁Xₙ, where M represents an early transition metal, X is carbon and/or nitrogen and n=1, 2, 3, or 4. The etching process may occur via a direct hydrofluoric acid treatment (harsh) or an in situ generation of hydrofluoric acid through the protonation of an aqueous fluoride-containing salt in a hydrochloric acid solution (mild), which results in surface terminations (Tₓ) of fluoride, oxide, hydroxide and chloride on the metal surface. Thus, the MXene general formula may be denoted as Mₙ₊₁XₙTₓ.

The intrinsic properties of MXenes can be determined by the transition metal in the MAX phase material. Therefore, magnetic MXenes according to some embodiments are based on magnetic transition metal elements such as Cr, V, Mn, Mo, Fe, Co and Ni. However, MXenes based on nonmagnetic transition metals are also predicted to be magnetic and their optical, electronic and magnetic properties can be influenced by defects, different surface terminating groups and synthetic procedures. In particular, the magnetic behavior of Ti₃C₂Tₓ reduced by Li-ethylenediamine has demonstrated powders to be Pauli paramagnets above 10 K with a temperature dependent Curie term below this. It has also been demonstrated that etching Al from a Ti₃AlC₂ MAX phase resulted in Ti₃C₂Tₓ MXenes with a mixed antiferromagnetic/paramagnetic behavior that depends on surface functionalization. Recent density functional theory calculations for different magnetic configurations of Ti₂C show that the AFM had the lowest energy but an applied external electric field could tune the monolayer from the AFM state to a ferrimagnetic one. Earlier calculations also revealed that surface functionalized MXenes were magnetic and differed from their parent MAX phase. It has also been experimentally confirmed that the presence of atomic defects in layers can alter the magnetic properties of MXenes. In addition, MXenes exhibit a diverse magnetic behavior depending on the doping, applied electric field, and chemical composition. Therefore, MXenes are emerged as promising 2D magnetic materials and may be used to fabricate magnetic devices such as spin-valves, spin-filters, magnetic tunnel junctions (MTJ) and magnetic random access memories (MRAM).

According to aspects of the present technology, magnetic behavior in MXenes, for example titanium carbide MXenes can be controlled in the fabrication and/or preparation of these MXene materials, for instance by controlling the etching processes. In accordance with some aspects, a starting material of Ti₃AlC₂ having ferromagnetic properties can be translated to a complex AFM-PM configuration in MXenes prepared through controlled etching. In some instances, the AFM-PM transition temperature can be controlled by and dependent on the extent of etching of the MAX material (e.g. Ti₃AlC₂). In some aspects, a direct quantitative correlation can be achieved between the extent of Al etching in a MAX phase material and a AFM-PM transition temperature in a MXene material or composition as contemplated herein.

In some embodiments, antiferromagnetic ordering in titanium carbide (Ti₃C₂Tₓ) MXenes can be achieved through controlled etching. It will be appreciated that in other embodiments, antiferromagnetic MXenes can be produced based on other materials and/or elements as described herein. Synthetic routes and/or procedures are provided for influencing the magnetization and/or the magnetic susceptibility and the Neel temperatures of any number of MXenes, such as a titanium carbide. For instance, according to some embodiments, the Néel temperature for an MXene can be tuned from around 50K to above room temperature, dependent on the extent of etching in the preparation of an MXene material, which is needed in some instances in relation to the development of practical antiferromagnetic memory devices.

In some embodiments, tunable MXenes, methods of forming MXene based materials, and methods of tuning such MXenes are provided. In some instances, a MXene according to the present technology can have a general formula of Mₙ₊₁Xₙ, for example Ti₃C₂Tₓ MXenes. Accordingly, a MAX phase material (i.e. metal, aluminum, carbo/nitride material), such as a Ti₃AlC₂, can be provided and etched to generate a MXene material.

According to some embodiments, methods of synthesizing a MXene material are provided. A starting MAX phase material can be selected, a reaction time and/or reaction temperature can be determined, and subsequently a MXene material can be generated through etching the MAX phase material in an etching solution based on at least one of the determined reaction time and/or reaction temperature. In some instances, the extent of etching may be controlled by adjusting the reaction time and/or the reaction temperature, thereby tuning the AFM-PM phase transition temperature of the MXene from about 50K to above room temperature. In some instances, the reaction temperature can be from about 20° C. to about 80° C. In some other instances, the reaction time can be from about 24 h up to about 168 h. In some embodiments, the etching solution can be a solution of LiF/HCl. In some further embodiments, the etching solution can be a solution of NaF/HCl. In some even further embodiments, the etching solution can be a solution of HF. In some even further embodiments, an extent of etching can be initially determined which can inform the determination of reaction temperature and/or time and/or etching solution to be used.

In some embodiments, the starting MAX phase material can be pre-processed by exposing the material to microwave radiation prior to etching, for instance the MAX phase material can be processed with microwave radiation up to a determined power (e.g. 800 W) for a determined amount of time. In some instances, adjusting the power and the time of preprocessing can influence the extent of etching.

After etching via an etching solution (e.g. LiF/HCl), a washing step can be completed to generate the MXene phase, subsequently the “wet” MXene phase can be heated to remove intercalated and/or surface bound water. In some example embodiments, the MXene can be heated at about 120° C. for about 24 hours.

In some embodiments, the synthesized and/or generated MXene can be separated into a single and/or a plurality of layers, for instance via ultra-high frequency sonication.

In some instances, the single and/or plurality of layers, i.e. flexible single-layer MXene sheets which are synthesized can be rolled, for example into nanoshells and/or microshells through ultracentrifugation. In some instances, the rolling can be done in a solution at speeds from about 4,000 rpm to about 60,000 rpm, for instance about 16,000 rpm to form the nanoshells and/or microshells. It will be appreciated that the extent of rolling can be controlled by the choice of solution (i.e. solvent) which can affect complete delamination of multilayer MXenes into single-layer MXenes.

In some further embodiments, prepared MXene thin films (e.g. antiferromagnetic MXene thin films can be subsequently prepared through solution processing, for instance spin coating or dip coating. In some even further embodiments, solutions of nanoparticle antiferromagnetic MXenes can be three-dimensionally (3D) printed on to a substrate, for example as a memory device. Accordingly, synthesized MXenes can be dispersed in water and other polar solvents, e.g, dimethyl sulfoxide (DMSO), methanol, ethanol, isopropanol, and dimethylformamide (DMF), to prepare thin films which can be used to fabricate flexible antiferromagnetic memory devices. Thin film morphology is tuned by sonication rate and energy using tip sonicator to manipulate the electrical and magnetic properties.

Methods described herein can further comprise application of synthesized MXenes and their processing into nanomaterials, for instance in their application into magnetoresistive devices, in particular at ambient temperature. It will be appreciated that antiferromagnets are quasi-magnetic materials with the potential to hold far more data in a computer's memory than traditional ferromagnetic materials. Magnetoresistive random-access memory (MRAM) based on antiferromagnetic materials is nonvolatile “permanent”, meaning that it does not need a steady supply of power to retain data. This is a tremendous advantage over the conventional volatile technologies, dynamic random-access memory (DRAM) and static random-access memory (SRAM), that do require a steady supply of power to retain data. MRAM is able to read and write data at faster speeds to DRAM and SRAM, with much less power consumption, which puts a strain on portable electronic devices. In antiferromagnets, the spins of electrons on neighboring atoms point opposite to each other, resulting in no net magnetic field. However, the collective orientation of all spins in an antiferromagnet can still record data, but they aren't influenced by an external magnetic field, resulting in a higher memory density. Additionally, the time-scale for spin-flips in antiferromagnetics are on the order of picoseconds (terahertz frequency) which 1000 times faster than the nanosecond (gigahertz frequency) of DRAM and SRAM.

Embodiments described herein are further illustrated, and can be understood more readily in the following non-limiting examples. Elements, apparatus, and methods described herein, however, are not limited to any specific embodiment presented in the examples. It should be recognized that these are merely illustrative of some principles of this disclosure, and are non-limiting. Numerous modifications and adaptations will be readily apparent without departing from the spirit and scope of the disclosure.

In some embodiments, the fabrication and/or synthesis of MXene materials, for instance Ti₃C₂Tₓ MXenes, are provided. According to some example embodiments, Ti₃C₂Tₓ MXenes (which are robust to oxidation) are synthesized using an inorganic solution, for instance a solution of lithium fluoride (LiF) and/or hydrochloric acid (HCl). According to examples described herein, the extent of etching of a MAX phase material, or the extent of aluminum (Al) removal can be controlled by performing multiple syntheses, for example one synthesis at ambient temperature and another at an elevated temperature. Additionally, one synthesis can be carried out over a shorter etching or reaction time and another can be carried out over a longer etching or reaction time.

As shown in the following illustrative examples, the contents of the etched phase and the unetched one were probed using XRD, as discussed below. The magnetic property of the resulting Ti₃C₂Tₓ MXene was analyzed using a superconducting quantum interference device (SQUID) and the extent of etching was determined by using XRD. Consequently, a AFM-PM phase transition was observed in samples generated by both synthesis techniques that occurred at different Neel temperatures, indicating that the aluminum content mediates the magnetic transition.

A sample (20 g) of MAX phase Ti₃AlC₂ powder is provided and further milled in a planetary mill using a zirconia jar (45 cm³) and two zirconia balls (12.7 mm in diameter). A milling energy of ⅓ hp was used at a milling rate of 1725 rpm for about 45 min.

Batch 1 Ti₃C₂Tₓ was prepared by etching Al from the milled Ti₃AlC₂ powder in a solution containing 1.33 g lithium fluoride (LiF) dissolved in 100 mL of 6 M hydrochloric acid (HCl) solution. First, 2.00 g Ti₃AlC₂ powder was slowly added into the 100 mL LiF/HCl solution and magnetically stirred at 400 rpm for about 24 h at a temperature of 21° C. The mol ratio of LiF and Ti₃AlC₂ in this mixture was 5:1. The crude Ti₃C₂Tₓ product was collected and centrifuged at 4500 rpm for 10 min and further washed first with 6 M HCl for 3 cycles and then with deionized (DI) water repeatedly; the resultant samples were centrifuged for 15 minutes until the resulting supernatant reached a pH>6. The supernatant contained a green coloration indicating that delamination of the Ti₃C₂Tₓ nanosheets was occurring. The Ti₃C₂Tₓ product was vacuum filtered and air dried at room temperature for 24 h before storage. The mass of the obtained product was 1.57 g.

Batch 2 Ti₃C₂Tₓ was prepared in a solution containing 1.93 g LiF dissolved 100 mL of 6 M HCl solution. First, 2.90 g Ti₃AlC₂ powder was slowly added into the 100 mL LiF/HCl solution and magnetically stirred at 400 rpm for 166 h at 35° C. The mol ratio of LiF and Ti₃AlC₂ in this mixture was also 5:1. The crude product was washed using the same procedure as done in Batch 1 and then allowed to air dry at room temperature for 24 h followed by heating at 125° C. for 45 min. The mass of the obtained purified product was 2.00 g.

The XRD measurements were conducted on a Rigaku Miniflex 600 X-ray Diffractometer operated at a 20 kV voltage and a 2 mA current. The XRD pattern of the Ti₃AlC₂ MAX phase and Ti₃C₂Tₓ MXene powder samples were taken over the scan range from 5° to 90° at a scan rate of 0.075°/min. The magnetic behavior of the Ti₃AlC₂ powders and the etched Ti₃C₂Tₓ MXene samples was measured in a Quantum Design SQUID vibrating sample magnetometer over the temperature range 2-300 K with applied magnetic fields from 0-2 T. For these measurements, samples were mounted on a quartz holder with GE 7031 varnish. It was confirmed that there was no magnetic contribution from the holder and varnish prior to these measurements. For the morphological characterization, a solution of MXene was spin-coated on a glass substrate at 1000 rpm. SEM images were then collected. Topographic images of tapping mode atomic force microscopy were taken using an atomic force microscope with a resolution of 512 points x 512 lines and a scanning rate of 1 line/s. A Bruker's Sharp Nitride Lever probe, SNL-10, with a normal frequency 65 kHz and a normal spring constant of 0.35 N/m was used in the scanning.

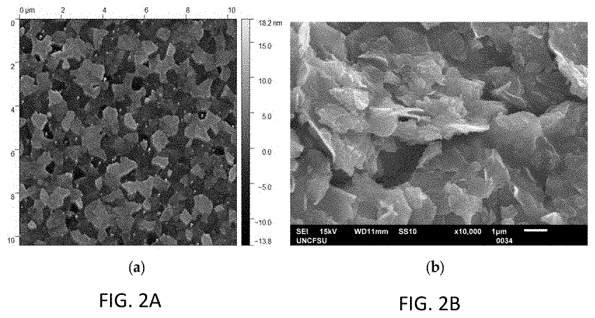

The XRD measurements were conducted to determine the crystal structure of the materials before and after LiF/HCl etching. Referring to FIG. 2, the XRD patterns of the Ti₃AlC₂ and Ti₃C₂Tₓ samples are shown in the scan range 5-90° where Tₓ denotes the surface terminations (O²⁻, OH⁻ and F) on the sample MXene sheet.

The lowest Bragg peak for the (002) reflection of the Ti₃AlC₂ powder occurred at 9.70° with its second-order reflection at ˜19° and several other allowed (hkl) reflections over the range. After LiF/HCl etching at room temperature (Batch 1), the (002) peak broadened and shifted towards a smaller angle (7.2°) compared with the unetched Ti₃AlC₂, indicating that Al was replaced by —F or —OH moieties especially near the surface region. A few Ti₃AlC₂peaks were still observed in Ti₃AlC₂ Batch 1, indicating the presence of some unreacted MAX phase in the bulk after the etching process. A contrasting XRD pattern was obtained when Ti₃AlC₂ was etched at 35° C. for 166 h (Batch 2). The (002) reflection was shifted to 8.30° and was much broader compared with Ti₃AlC₂. The peak shift to the smaller angle and hence the increase in the c-lattice parameter suggested that the surface functional groups and micro-molecules such as water molecules appeared between the MXene nanosheets. Additionally, the (004) reflection at 17.6° and the (006) at 26.5° were also broadened. Furthermore, the (104) peak at 39° was vanishingly small compared with the Ti₃AlC₂ and Ti₃C₂Tₓ Batch 1 samples. These observations indicated that Ti₃AlC₂ was transformed to Ti₃C₂Tₓ MXene with a less unreacted MAX phase in Batch 2 compared with Batch 1.

Referring now to FIG. 2A-2B, AFM and SEM images of a Ti₃C₂Tₓ MXene sample is shown. The surface roughness of the MXene flakes was characterized by atomic force microscopy in a tapping mode. The topographic image FIG. 2A shows clear sheet structures with an average height of 16 nm, a mean area of 1005 nm² and a mean roughness of 2.98 nm. The minimum thickness of the MXene sheets was around 2-3 nm, which corresponded to a few layers of two dimensional MXene flake nano structures. The SEM image, illustrated by FIG. 2B, shows that the synthesized Ti₃C₂Tₓ MXene exhibits a discrete layered/sheet structure with a well crystallized feature.

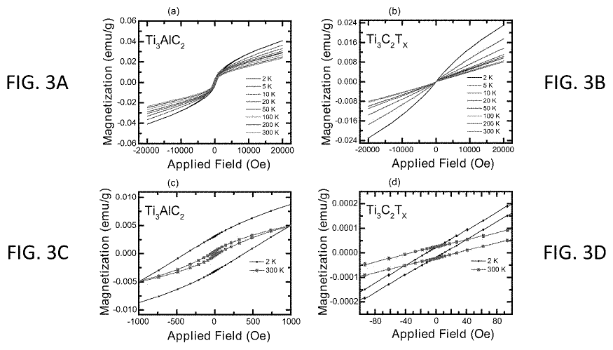

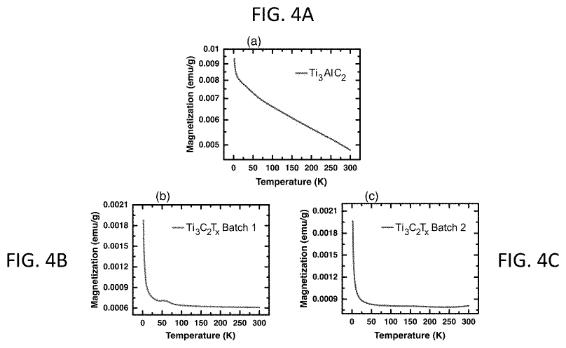

To illustrate how the extent of etching affected the magnetic properties, a SQUID VSM was used to measure the magnetic moment as a function of an applied magnetic field and temperature in an applied magnetic field of 1 kOe. FIGS. 3A-3D shows the field dependent magnetization from 2-300 K of the Ti₃AlC₂ and Ti₃C₂Tₓ samples while the temperature dependent magnetization (M(T)) of the Ti₃AlC₂ and etched Ti₃C₂Tx samples at 1 kOe are shown in FIGS. 4A-C.

It will be appreciated that in FIG. 3C, the coercivity of the Ti₃AlC₂ MAX phase was 380 Oe at 2 K but reduced to 50 Oe at 300 K. However, the coercivity for the Ti₃C₂Tₓ MXene shown in FIG. 3D was 25 Oe at 300 K and 12 Oe at 2 K. The larger coercivities in the MAX phase suggest that it was ferromagnetic although the hysteresis loops did not saturate at 2T. One should also note that the magnetization at 2 K and 20,000 Oe was 0.04 emu/g for the MAX phase and 0.02 emu/g for the Ti₃C₂Tₓ MXene. It could be suggested that a lack of saturation indicates an AFM phase although small coercivity may indicate an AFM phase or a ferromagnetic one with weakly bonded MXene phase monolayers.

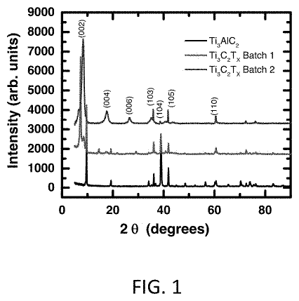

Consistent with the M vs. H data shown in FIG. 3, the M vs. T behavior of Ti₃AlC₂ shown in FIG. 4 indicates that it is ferromagnetic in nature. It has been reported in other instances that MAX phases exhibit Pauli paramagnetism, however, it has also been noted that in some instances a Ti₃AlC₂ sample did not exhibit an EPR signal, which should have been present the MAX phase was a Pauli paramagnet. In other instances, prior to the technology described herein, no field or temperature dependent magnetization data has been shown that would demonstrate a MAX phase sample was paramagnetic. Accordingly, as illustrated in FIGS. 4B and C, it is seen that the M versus T data for the etched MXene samples and indicate that they achieve paramagnetic (PM) qualities at higher temperatures but exhibit a more complex behavior at lower temperatures. It will be appreciated that the temperature independent behavior at higher temperatures, illustrated by FIGS. 4B and 4C shown that the etched MXenes described herein are Pauli paramagnets. According to the examples provided herein, it can be seen that an AFM-like cusp is created around −70 K for the Ti₃C₂Tₓ Batch 1 sample that indicated an AFM-PM phase transition. Further, with a more thorough etching and/or aluminum removal of aluminum in Batch 2, the cusp is seen to shift towards a higher Neel temperature. Additionally, the magnetization of both batches of etched samples at 2 K was the same and was only one-fifth of the magnetization of Ti₃AlC₂. The more complete removal of Al was indicated by the vanishingly intense (104) X-ray reflection at 39° as illustrated in FIG. 1. This indicates that different magnetic behavior and/or a magnetic phase transition is influenced by control over etching (e.g. can be influenced by the presence of unetched Al). Also, FM behavior in the unetched Ti₃AlC₂ can be mediated by Al, and more specifically by Al content in the near surface region of the material. After etching, Ti₃AlC₂ transformed to Ti₃C₂Tₓ with a much smaller amount of Al where A1³⁺ acted as a self-dopant causing complex AFM-PM behavior in the Ti₃C₂Tₓ MXene.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A method of synthesizing a MXene material, the method comprising:
providing a MAX phase material;
determining at least one of a reaction time and a reaction temperature;
etching the MAX phase material based on the at least one reaction time and reaction temperature using an etching solution; and
generating the MXene material.

2. The method of claim 1, comprising determining the reaction time and the reaction temperature, and etching the MAX phase material based on both the determined reaction time and the reaction temperature.

3. The method of claim 1, further comprising tuning a antiferromagnetic-paramagnetic phase transition temperature of the MXene from about 50K to above room temperature.

4. The method of claim 1, further comprising processing the MAX phase material by a microwave prior to etching.

5. The method of claim 4, further comprising processing the MAX phase material at a determined power level and for a determined time.

6. The method of claim 1, further comprising sonicating the generated MXene material into a MXene layer or a plurality of MXene layers.

7. The method of claim 1, wherein the etching solution comprises an LiF/HCl solution.

8. The method of claim 1, wherein the MAX phase material is milled to the nanoscale prior to etching.

9. The method of claim 1, wherein the etching solution comprises a NaF/HCl solution.

10. The method of claim 1, wherein the etching solution comprises an HF solution.

11. The method of claim 6, wherein the MXene layer or plurality of MXene layers are rolled into a shell form via ultracentrifugation.

12. The method of claim 11, wherein the rolling is done at a speed of about 4,000 rpm to about 60,000 rpm.

13. The method of claim 1, wherein the reaction temperature is at ambient temperature.

14. The method of claim 13, wherein the reaction temperature is from about 20° C. to about 80° C.

15. The method of claim 1, wherein the reaction time is at least 24 h.

16. The method of claim 15, wherein the reaction time is up to about 168 h.

17. The method of claim 6, wherein the plurality of layers is completely delaminated into a single layer MXene.

18. A method of preparing a MXene thin film comprising:
providing a MXene of claim 1;
processing, by a solution, the MXene; and
generating an antiferromagnetic MXene thin film.

19. The method of claim 16, wherein the processing comprises at least one of physical vapor deposition, spin coating, blade coating, spray coating, and dip coating.

20. An antiferromagnetic MXene material synthesized by a method of claim 1.
